(19) United States
(12) Patent Application Publication
(10) Pub. No.: US 2004/0212832 A1
(43) Pub. Date: Oct. 28, 2004

(54) Image formation method, data processing method, image forming system, and image forming apparatus

(76) Inventor: Tetsuya Shibata, Yawata-shi (JP)

Correspondence Address: BIRCH STEWART KOLASCH & BIRCH, PO BOX 747, FALLS CHURCH, VA, 22040-0747, US

(21) Appl. No.: 10/819,992

(22) Filed: Apr. 8, 2004

(30) Foreign Application Priority Data
Apr. 11, 2003 (JP) 2003-107735

(51) Int. Cl. G06F 15/00; H04N 1/40

(52) U.S. Cl. 358/1.16; 358/1.15

(57) ABSTRACT

In an image forming apparatus, image data such as facsimile data is received, the received image data is recorded in an internal image recording section, and copied data obtained by copying the image data is transmitted to a recording apparatus connected to an internal communication network such as a LAN. In the recording apparatus, the received copied data is recorded. The image forming apparatus performs an image formation process based on the image data recorded in the image recording section. When abnormality is detected in the image formation process, the copied data recorded in the recording apparatus is used.

### CROSS REFERENCE TO RELATED APPLICATIONS

This Nonprovisional application claims priority under 35 U.S.C. §119(a) on Patent Application No. 2003-107735 filed in Japan on Apr. 11, 2003, the entire contents of which are hereby incorporated by reference.

### BACKGROUND OF THE INVENTION

The present invention relates to an image formation method and a data processing method using an image forming apparatus such as a facsimile machine and a recording apparatus communicating with the image forming apparatus, an image forming system adopting these methods, and an image forming apparatus used in the system, and more particularly relates to an image formation method, a data processing method, an image forming system, and an image forming apparatus, which back up image data subjected to image formation using an image forming apparatus and a recording apparatus connected to a communication network such as a LAN.

In an image forming apparatus such as a facsimile machine, received image data is recorded in recording means such as an internal flash memory, an image formation process is performed based on the recorded image data, and the image data recorded in the recording means is promptly deleted after the image formation process. The reason why image data recorded in the recording means is promptly deleted is that it is necessary to ensure an available capacity of the recording means since image data transmitted to the image forming apparatus is on the increase with the spread of communication technologies and the size of the respective image data becomes larger, and it is possible to efficiently use expensive recording means with small recording capacity by promptly ensuring an available capacity.

As a method of efficiently using the recording means with small recording capacity, there is disclosed a technique in which, when the available capacity of the recording means is less than a predetermined value, image data to be transmitted or received is transferred to another image forming apparatus, and an image formation process is performed in the image forming apparatus to which the image data is transferred (for example, Japanese Patent Application Laid-Open No. 4-38066/1992).

However, in conventional image forming apparatuses including the technique disclosed in Japanese Patent Application Laid-Open No. 4-38066/1992, the image data recorded in the recording means is promptly deleted after an image formation process, and therefore, even if abnormality occurs in the image formation process, the image data recorded in the recording means cannot be referred to, and there is the problem that an appropriate measure, such as recovery of the image data, cannot be taken against the abnormality. Moreover, in the case where the recording capacity of the recording means is increased, there is the problem that the image forming apparatus becomes expensive.

### BRIEF SUMMARY OF THE INVENTION

The present invention has been made with the aim of solving the above problems, and it is an object of the present invention to provide an image formation method, a data processing method, an image forming system and an image forming apparatus, capable of taking an appropriate measure against occurrence of abnormality in an image formation process, even when image data is deleted promptly after the image formation process due to a small recording capacity of recording means of the image forming apparatus, by recording copied data obtained by copying image data received by the image forming apparatus in a recording apparatus, such as a FTP server computer, and transmitting the copied data to the image forming apparatus from the recording apparatus when abnormality is detected in the image formation process.

An image formation method of the present invention is an image formation method using an image forming apparatus, which has recording means for recording image data and deletes image data recorded in the recording means after an image formation process based on the image data, and a recording apparatus communicating with the image forming apparatus, wherein the image forming apparatus receives image data, records the received image data in the recording means and transmits copied data obtained by copying the image data to the recording apparatus, and the recording apparatus records the received copied data, and further the image forming apparatus performs an image formation process based on the image data recorded in the recording means.

In the image formation method of the present invention, by connecting the image forming apparatus such as a facsimile machine and the recording apparatus such as a FTP server computer through a communication network such as a LAN and by causing the image forming apparatus to record copied data obtained by copying received image data in the recording apparatus, even when abnormality is detected in the image formation process, it is possible to use the copied data recorded in the recording apparatus, and therefore it is possible to take an appropriate measure, such as recovery of the image data, without increasing the recording capacity of the recording means.

A data processing method of the present invention is a data processing method using a data processor for performing data processing based on object data to be processed, and a recording apparatus communicating with the data processor, wherein the data processor receives object data to be processed and transmits copied data obtained by copying the received object data or copying relevant data related to the object data, to the recording apparatus, and the recording apparatus records the copied data received from the data processor, and further the data processor performs data processing based on the object data, and transmits to the recording apparatus a copied data transmission request for transmission of the copied data when abnormality is detected in the data processing.

In the data processing method of the present invention, by connecting the data processor such as a facsimile machine and recording means such as a FTP server computer through a communication network such as a LAN and by causing the data processor to record copied data obtained by copying received object data to be processed, such as image data, or copied data obtained by copying relevant data such as previous object data related to received object data to be processed, such as address data, in the recording apparatus and transmitting the copied data from the recording apparatus to the image forming apparatus when abnormality is detected in an image formation process based on the object data which is image data, or when abnormality is detected in an updating process of the object data which is address data, it is possible to take an appropriate measure even when the object data is promptly deleted after data processing due to a small recording capacity of the recording means of the image forming apparatus.

An image forming system of the present invention is an image forming system comprising an image forming apparatus, which has first recording means for recording image data and deletes image data recorded in the first recording means after an image formation process based on the image data, and a recording apparatus having second recording means and communicating with the image forming apparatus, wherein the image forming apparatus comprises: means for receiving image data; means for recording the image data in the first recording means; means for transmitting copied data obtained by copying the image data to the recording apparatus; and means for performing an image formation process based on the image data, and the recording apparatus comprises means for recording the received copied data in the second recording means.

In the image forming system of the present invention, by connecting the image forming apparatus such as a facsimile machine and the recording apparatus such as a FTP server computer through a communication network such as a LAN and by causing the image forming-apparatus to record copied data obtained by copying received image data in the recording apparatus, it is possible to perform a backup process in anticipation of abnormality in the image formation process, without increasing the recording capacity of the recording means of the image forming apparatus.

In the image forming system of the present invention, the image forming apparatus further comprises: means for transmitting to the recording apparatus a copied data transmission request for transmission of the copied data when abnormality is detected in the image formation process; means for receiving the copied data transmitted in response to the copied data transmission request; and means for performing an image formation process based on the received copied data.

In the image forming system of the present invention, by transmitting the copied data from the recording apparatus to the image forming apparatus and performing an image formation process when abnormality, such as breakdown of the recording means and damage of the image data, is detected in an image formation process, the image formation process can be performed even when abnormality occurs, and therefore it is possible to improve reliability.

In the image forming system of the present invention, the image forming apparatus comprises deletion request transmitting means for transmitting a copied data deletion request for deletion of copied data to the recording apparatus after the image formation process, and the recording apparatus comprises means for deleting the copied data recorded in the second recording means, based on the received copied data deletion request.

In the image forming system of the present invention, by deleting the copied data recorded in the recording apparatus when the image formation process has been finished correctly, the second recording means of the recording apparatus can be efficiently used, and it is possible to prevent leakage of the copied data recorded in the second recording means and improve security.

In the image forming system of the present invention, the image forming apparatus further comprises means for measuring time elapsed since an image formation process, and the deletion request transmitting means transmits a copied data deletion request after a predetermined time has elapsed since the image formation process.

In the image forming system of the present invention, since the copied data recoded in the recording apparatus is deleted after a predetermined time has elapsed since an image formation process, when printing abnormality such as a missing part of print is confirmed after the image formation process, it is possible to acquire the copied data from the recording apparatus and perform an image formation process because the copied data is still recorded within the predetermined time after completion of the image formation process.

In the image forming system of the present invention, the image forming apparatus further comprises means for calculating a total value of volume of the copied data recorded in the recording apparatus, and the deletion request transmitting means transmits a copied data deletion request when the calculated total value exceeds a predetermined value.

In the image forming system of the present invention, when the total value of volume of the copied data recorded in the recording apparatus exceeds a predetermined value, for example, by deleting the copied data in the order of the recorded date so that the copied data with the oldest recorded time is deleted first, it is possible to store the copied data as long as the recording apparatus has sufficient recording capacity, and therefore, when printing abnormality such as a missing part of print is confirmed after an image formation process, it is possible to acquire the copied data recorded in the recording apparatus and perform an image formation process.

In the image forming system of the present invention, the image forming apparatus further comprises: means for judging whether or not it is possible to record the image data in the first recording means, based on an available capacity of the first recording means; means for transmitting a part or all of image data to the recording apparatus when recording of the image data in the first recording means is judged impossible; means for transmitting to the recording apparatus an image data transmission request for transmission of the image data; means for receiving the image data transmitted in response to the image data transmission request; and means for transmitting an image data deletion request for deletion of the image data to the recording apparatus after the image formation process, and the recording apparatus further comprises: means for recording the received image data in the second recording means; means for transmitting the image data recorded in the second recording means in response to the received image data transmission request; and means for deleting the image data recorded in the second recording means, based on the received image data deletion request.

In the image forming system of the present invention, by recording a part or all of the image data in the recording apparatus when the available capacity of the first recording means of the image forming apparatus is insufficient, it is possible to avoid the situation where receiving of image data is delayed due to insufficient available capacity of the first recording means and a communication line is occupied.

In the image forming system of the present invention, the image forming apparatus further comprises means for determining a receiver of the image data from a plurality of the recording apparatuses.

In the image forming system of the present invention, by determining a recording location of the image data from a plurality of the recording apparatuses in the case where the available capacity of the first recording means of the image forming apparatus is insufficient, it is possible to select a recording apparatus with superior basic performance such as recording capacity, and select an appropriate recording method according to processing conditions, such as recording the data in a plurality of recording apparatuses in a divided manner.

In the image forming system of the present invention, the image forming apparatus further comprises: means for detecting an available capacity of the second recording means of a first recording apparatus in a plurality of the recording apparatus; means for judging whether or not it is possible to record copied data in the first recording apparatus, based on the detected available capacity and size of copied data to be transmitted; and means for transmitting a part or all of the copied data to a second recording apparatus different from the first recording apparatus when recording of the copied data in the first recording apparatus is judged impossible.

In the image forming system of the present invention, when the available capacity of the second recording means of the recording apparatus is insufficient, by changing the recording location of copied data to another recording apparatus, it is possible to record a large volume of copied data.

An image forming apparatus of the present invention is an image forming apparatus having recording means and performing an image formation process based on image data, and comprises: means for receiving image data; means for recording the image data in the recording means; means for transmitting copied data created by copying the image data to another apparatus; and means for performing an image formation process based on the image data.

In the image forming apparatus of the present invention, by connecting to another apparatus such as a FTP server computer through a communication network such as a LAN and by recording copied data obtained by copying received image data in the another apparatus, it is possible to perform a backup process in anticipation of abnormality in the image formation process, without increasing the recording capacity of the recording means of the image forming apparatus.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram showing the configuration of an image forming system of Embodiment 1;

FIG. 2 is a flowchart showing an image formation process of an image forming apparatus and a recording apparatus used in the image forming system of Embodiment 1;

FIG. 3 is an explanatory view showing the concept of a job number list recorded in a job management section of the image forming apparatus of Embodiment 1;

FIG. 4 is a flowchart showing a copied data deletion first process of the image forming apparatus and the recording apparatus used in the image forming system of Embodiment 1;

FIG. 5 is a flowchart showing a copied data deletion second process of the image forming apparatus and the recording apparatus used in the image forming system of Embodiment 1;

FIG. 6 is a flowchart showing a copied data deletion third process of the image forming apparatus and the recording apparatus used in the image forming system of Embodiment 1;

FIG. 7 is a flowchart showing a copied data image formation process of the image forming apparatus and the recording apparatus used in the image forming system of Embodiment 1;

FIG. 8 is a flowchart showing an image data rerecording process of the image forming apparatus and the recording apparatus used in the image forming system of Embodiment 1;

FIGS. 9A through 9C are explanatory views showing the concept of an image data saving process of the image forming system of Embodiment 1;

FIGS. 10A and 10B are a flowchart showing the image data saving process of the image forming apparatus and the recording apparatus used in the image forming system of Embodiment 1;

FIG. 11 is a block diagram showing the configuration of an image forming system of Embodiment 2;

FIGS. 12A and 12B are a flowchart showing an image formation process of an image forming apparatus, a first recording apparatus and a second recording apparatus used in the image forming system of Embodiment 2;

FIGS. 13A through 13C are explanatory views showing the concept of an image data saving process of the image forming system of Embodiment 2;

FIGS. 14A through 14C are explanatory views showing the concept of an image data saving process of the image forming system of Embodiment 2;

FIGS. 15A and 15B are a flowchart showing the image data saving process of the image forming apparatus, the first recording apparatus and the second recording apparatus used in the image forming system of Embodiment 2; and

FIG. 16 is a flowchart showing an address book updating process of an image forming apparatus and a recording apparatus used in an image forming system of Embodiment 3.

### DETAILED DESCRIPTION OF THE INVENTION

The following description will specifically explain the present invention with reference to the drawings illustrating some embodiments thereof

### EMBODIMENT 1

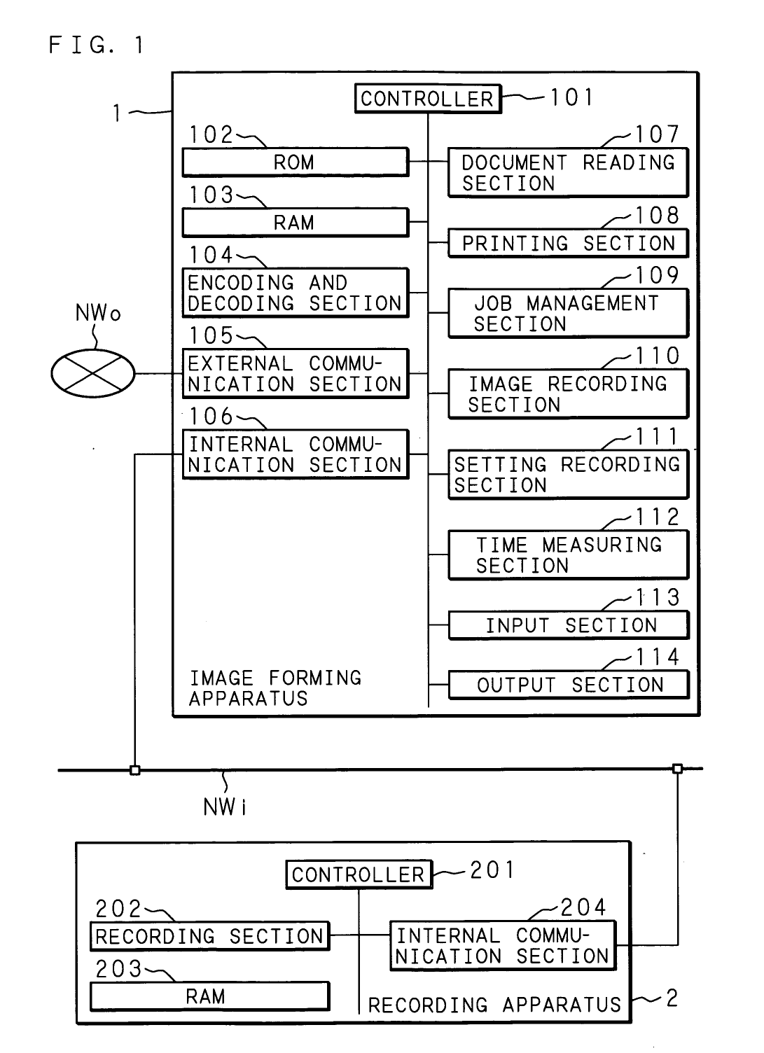

FIG. 1 is a block diagram showing the configuration of an image forming system of Embodiment 1 of the present invention. In FIG. 1, numeral 1 represents an image forming apparatus (data processor), such as a facsimile machine and a digital multi-function machine, for forming and printing an image based on received image data, and the image forming apparatus 1 is connected to an internal communication network NWi, such as a LAN (Local Area Network), and an external communication network NWo, such as a telephone communication network. A recording apparatus 2 such as a FTP (File Transfer Protocol) server computer is connected to the internal communication network NWi.

The image forming apparatus 1 comprises a controller 101 such as a CPU for controlling the entire apparatus; a ROM 102 for recording various types of information such as a program and data necessary for controlling the apparatus; and a RAM 103 for temporarily storing data generated during execution of a program recorded in the ROM 102. Note that a part of the recording area of the RAM 103 is used as a receiving buffer for temporarily recording image data such as facsimile data received through the external communication network NWo. Moreover, the image forming apparatus 1 comprises an encoding and decoding section 104 for performing encoding to modulate an analog signal to a digital signal and decoding to modulate a digital signal to an analog signal when transmitting and receiving image data such as facsimile data through the external communication network NWo; an external communication section 105 for transmitting and receiving various types of information such as image data through the external communication network NWo; and an internal communication section 106 for communicating with the recording apparatus 2 through the internal communication network NWi.

Further, the image forming apparatus 1 comprises a document reading section 107 such as a scanner for reading a document to be read and generating image data when transmitting or copying the document to be read; a printing section 108 such as a printer engine for performing printing based on received image data; a job management section 109 for managing the recorded conditions and recorded location of image data and copied data created by copying the image data; and an image recording section (first recording means) 110, such as a hard disk and a flash memory, for recording image data generated based on a document read by the document reading section 107, or image data received from outside, to print the image data. In addition, the image forming apparatus 1 comprises a setting recording section 111 for recording various types of information, such as information indicating a communicating destination such as a facsimile number and settings concerning various kinds of processes; and a time measuring section 112 such as a timer for measuring time. Besides, the image forming apparatus 1 comprises, as man-machine interfaces, an input section 113 such as various keys and a touch panel for receiving operations of an operator; and an output section 114 such as a liquid crystal panel for displaying various types of information.

The recording apparatus 2 comprises a controller 201; a recording section (second recording means) 202 such as a hard disk; a RAM 203; and an internal communication section 204.

Next, the following description will explain the processes performed by various apparatuses used in the image forming system of Embodiment 1 of the present invention.

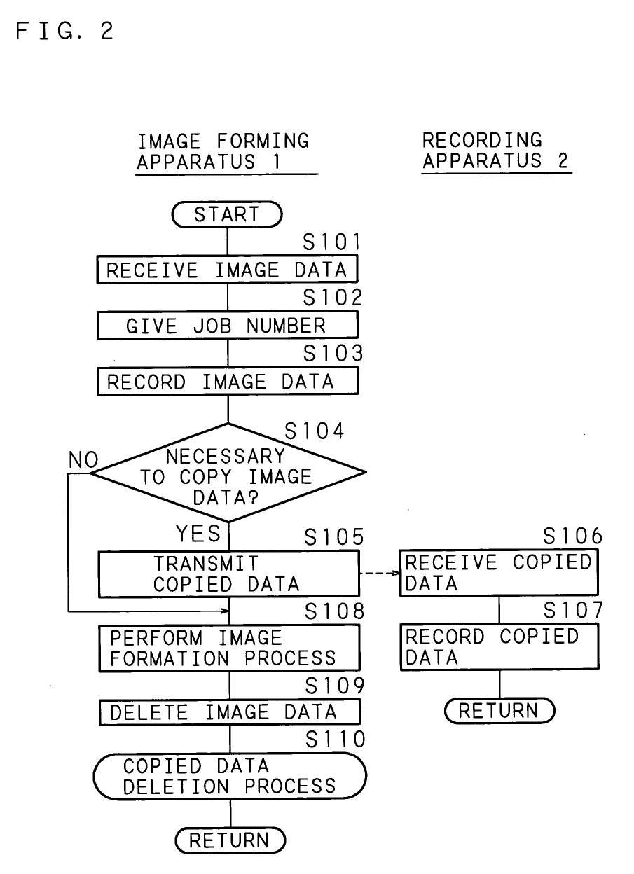

FIG. 2 is a flowchart showing an image formation process of the image forming apparatus 1 and the recording apparatus 2 used in the image forming system of Embodiment 1 of the present invention. In the image forming apparatus 1, under the control of the controller 101, image data such as facsimile data transmitted through the external communication network NWo is received by the external communication section 105 (S101), a job number for identifying the received image data is given (S102), and the image data having the job number is recorded as a job in the image recording section 110 (S103). At this time, a job number list indicating the index of the image data recorded in the image recording section 110 is recorded in the job management section 109.

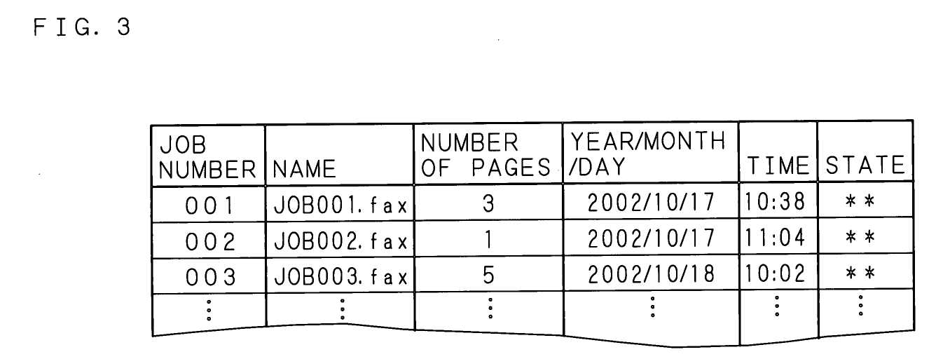

FIG. 3 is an explanatory view showing the concept of the job number list recorded in the job management section 109 of the image forming apparatus 1 of Embodiment 1 of the present invention. In the job number list of FIG. 3, the index of three pieces of image data recorded as jobs in step S103 is shown, and the job numbers, such as 001, 002 and 003, given to the respective jobs, the names of the image data, such as JOB001.fax, JOB002.fax, and JOB003.fax, the number of pages of the image data, year, month, day, and time, and the state of the image data are recorded in association with each other. In the column of the state, data indicating the state of a corresponding job, such as printing, completed, and interrupted, is recorded, and the recorded data is updated according to a change of the state. In the case where a plurality of pieces of image data are recorded, the job number list shown in FIG. 3 is used to manage the image data such as the printing order of the image data, and, for example, when image data is deleted after a process such as an image formation process, information showing the corresponding job is deleted from the job number list.

In the image forming apparatus 1, under the control of the controller 101, after completion of receiving and recording of image data, a judgment is made as to whether or not it is necessary to copy the image data recorded based on the settings recorded in the setting recording section 111, (S104), and, if copying of the image data is judged necessary (S104: YES), copied data obtained by copying the image data recorded in the image recording section 101 is transmitted to the recording apparatus 2 from the internal communication section 106 through the internal communication network NWi (S105). Besides, after transmitting the copied data for recording in the recording apparatus 2, the recorded conditions and recorded location of the copied data are recorded in the job management section 109. In step S104, if copying of the image data is judged unnecessary (S104: NO), the transmission process of copied data shown in step S105 is not performed.

In the recording apparatus 2, under the control of the controller 201, the copied data is received by the internal communication section 204 (S106), and the received copied data is recorded in the recording section 202 (S107). Since the recording apparatus 2 for recording the copied data is an internal apparatus connected to the internal communication network NWi, it is possible to increase security compared to the case where the copied data or image data is recorded in an external apparatus such as a mail server computer.

In the image forming apparatus 1, under the control of the controller 101, after completion of transmission of the coped data, an image formation process of forming an image to be printed and printing the image is performed by the processing of the printing section 108 based on the image data recorded in the image recording section 110 (S108), and the image data recorded in the image recording section 110 is deleted after the image formation process is finished (S109). Then, in the image forming apparatus 1, under the control of the controller 101, a copied data deletion process of transmitting, from the internal communication section 106 to the recording apparatus 2, a copied data deletion request for deletion of copied data based on the settings recorded in the setting recording section 111 is performed (S110). In the recording apparatus 2, based on the copied data deletion request received from the image forming apparatus 1, the copied data recorded in the recording section 202 is deleted.

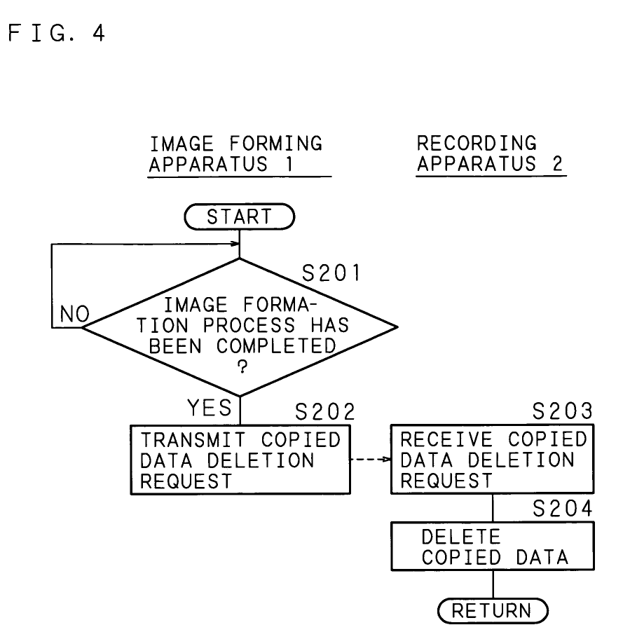

FIG. 4 is a flowchart showing a copied data deletion first process of the image forming apparatus 1 and the recording apparatus 2 used in the image forming system of Embodiment 1 of the present invention. The copied data deletion first process explained here is one mode of the copied data deletion process performed in step S110 of the image formation process explained using FIG. 2.

In the image forming apparatus 1, under the control of the controller 101, it is judged whether or not the image formation process has been completed (S201), and, if it is judged that the image formation process has been completed (S201: YES), a copied data deletion request for deletion of copied data corresponding to the image data based on which the image formation process has been completed is transmitted to the recording apparatus 2 from the internal communication section 106 (S202). If it is judged in step S201 that the image formation process has not been completed (S201: NO), the operation returns to step S201 after waiting for a predetermined time, and the image forming apparatus 1 repeats the following processes.

In the recording apparatus 2, under the control of the controller 201, the copied data deletion request is received by the internal communication section 204 (S203), and the copied data specified by the copied data deletion request is deleted from the recording section 202 based on the received copied data deletion request (S204). Thus, the copied data deletion first process is a mode of deletion of copied data in which corresponding copied data is deleted every time an image formation process has been completed, and, since the copied data is promptly deleted, it is possible to efficiently use the recording area of the recording section 202 of the recording apparatus 2, and it is also possible to avoid risks such as leakage of copied data by promptly deleting the copied data.

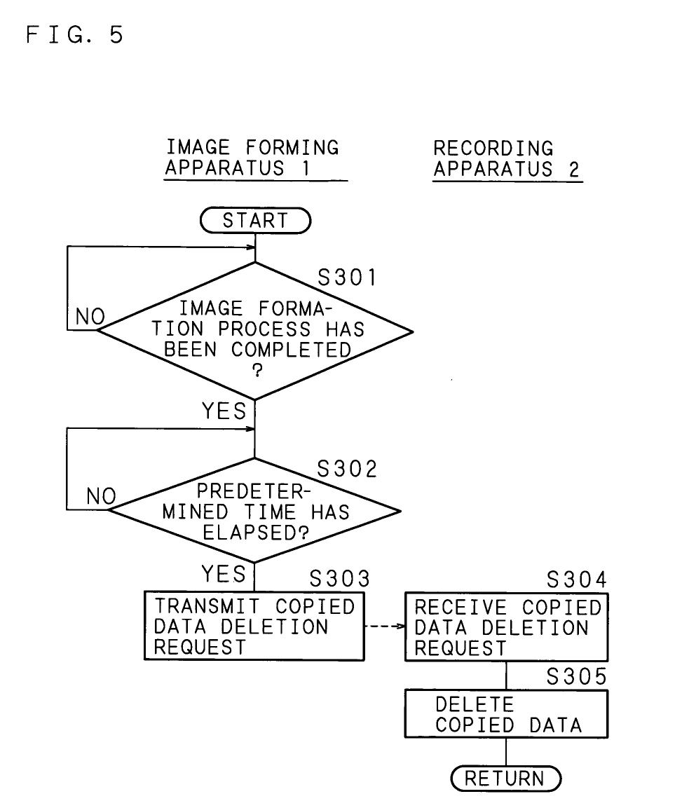

FIG. 5 is a flowchart showing a copied data deletion second process of the image forming apparatus 1 and the recording apparatus 2 used in the image forming system of Embodiment 1 of the present invention. The copied data deletion second process explained here is one mode of the copied data deletion process performed in step S110 of the image formation process explained using FIG. 2.

In the image forming apparatus 1, under the control of the controller 101, it is judged whether or not the image formation process has been completed (S301), and, if it is judged that the image formation process has been completed (S301: YES), it is judged whether or not the time measured from the completion of the image formation process by the time measuring section 112 exceeds a predetermined time (S302), and, if it is judged that the predetermined time has elapsed (S302: YES), a copied data deletion request for deletion of copied data corresponding to the image data used in the image formation process subjected to the judgment is transmitted to the recording apparatus 2 from the internal communication section 106 (S303). If it is judged in step S301 that the image formation process has not been completed (S301: NO), the operation returns to step S301 after waiting for a predetermined time, and the image forming apparatus 1 repeats the following processes. If it is judged in step S302 that the predetermined time has not elapsed (S302: NO), the operation returns to step S302 after waiting for a predetermined time, and the image forming apparatus 1 repeats the following processes.

In the recording apparatus 2, under the control of the controller 201, the copied data deletion request is received by the internal communication section 204 (S304), and the copied data specified by the copied data deletion request is deleted from the recording section 202, based on the received copied data deletion request (S305). Thus, in the copied data deletion second process, the copied data is deleted after a predetermined time has elapsed since the completion of the image formation process, and therefore, even when printing abnormality, such as a missing part of print, is confirmed after the image formation process, if the predetermined time has not elapsed, it is possible to perform image formation based on the recorded copied data by a later-described method.

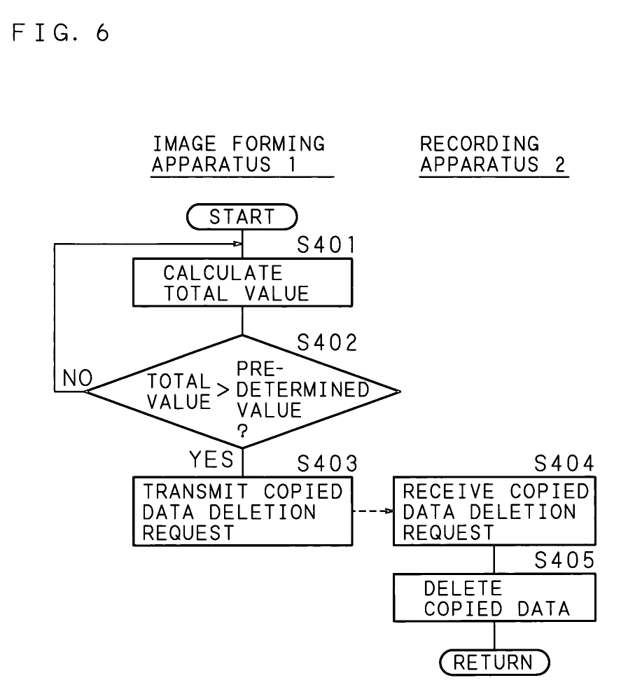

FIG. 6 is a flowchart showing a copied data deletion third process of the image forming apparatus 1 and the recording apparatus 2 used in the image forming system of Embodiment 1 of the present invention. The copied data deletion third process explained here is one mode of the copied data deletion process performed in step S110 of the image formation process explained using FIG. 2.

In the image forming apparatus 1, under the control of the controller 101, a total value of data volume of the copied data recorded in the recording apparatus 2 is calculated (S401), it is judged whether or not the calculated total value exceeds a predetermined value (S402), and, if it is judged that the total value exceeds the predetermined value (S402: YES), a copied data deletion request for deletion of copied data which is recoded first in terms of time among copied data for which an image formation process based on the corresponding image data is completed in the copied data recorded in the recording apparatus 2 is transmitted to the recording apparatus 2 from the internal communication section 106 (S403). If it is judged in step S402 that the calculated total value does not exceed the predetermined value (S402: NO), the operation returns to step S401 after waiting for a predetermined time, and the image forming apparatus 1 repeats the following processes.

In the recording apparatus 2, under the control of the controller 201, the copied data deletion request is received by the internal communication section 204 (S404), and the copied data specified by the copied data deletion request is deleted from the recording section 202, based on the received copied data deletion request (S405).

Thus, in the copied data deletion third process, by deleting copied data based on a FIFO (First-In First-Out) method in which the copied data recorded first is deleted first when the data volume of the copied data recorded in the recording apparatus 2 exceeds the predetermined value, it is possible to store copied data as long as the recording apparatus 2 has sufficient available capacity, and therefore, even when printing abnormality, such as a missing part of print, is confirmed after an image formation process, it is possible to perform image formation based on the recorded copied data by a later-described method.

Which of the above-mentioned copied data deletion first process, copied data deletion second process, and copied data deletion third process is to be performed is decided based on the settings recorded in the setting recording section 111. Needless to say, it may also be possible to perform a copied data deletion process other than the above-mentioned processes.

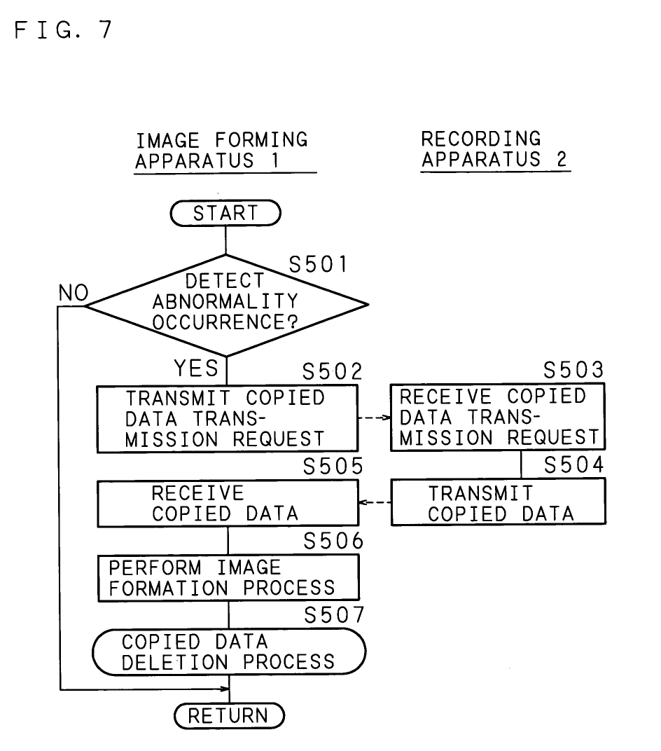

FIG. 7 is a flowchart showing a copied data image formation process of the image forming apparatus 1 and the recording apparatus 2 used in the image forming system of Embodiment 1 of the present invention. The copied data image formation process is an image formation process performed based on copied data recorded in the recording apparatus 2 when abnormality related to an image formation process, such as breakdown of the image recording section 110 and damage of image data, is detected.

In the image forming apparatus 1, under the control of the controller 101, it is detected whether of not abnormality related to an image formation process, such as breakdown of the image recording section 110 and damage of image data, occurs (S501), and, if abnormality is detected (S501: YES), a copied data transmission request for transmission of copied data is transmitted to the recording apparatus 2 from the internal communication section 106, based on the content recorded in the job management section 109 (S502). In step S501, instead of automatically detecting the presence of absence of abnormality by the image forming apparatus 1, it may be possible to receive an operation of an operator who confirmed the abnormality and regard this as the detection of abnormality. Besides, copied data requested to be transmitted does not include copied data corresponding to image data for which the image formation process has been completed correctly.

In the recording apparatus 2, under the control of the controller 201, the copied data transmission request is received by the internal communication section 204 (S503), and the copied data recorded in the recording section 202 is transmitted from the internal communication section 204 to the image forming apparatus 1 in response to the received copied data transmission request (S504).

In the image forming apparatus 1, under the control of the controller 101, the copied data is received by the internal communication section 106 (S505), and, after the completion of receiving of the copied data, an image formation process of forming an image to be printed and printing the image is performed by the processing of the printing section 108 based on the received copied data (S506). Then, in the image forming apparatus 1, under the control of the controller 101, a copied data deletion process of transmitting, from the internal communication section 106 to the recording apparatus 2, a copied data deletion request for deletion of copied data based on the settings recorded in the setting recording section 111 is performed (S507).

In the recording apparatus 2, the copied data recorded in the recording section 202 is deleted based on the copied data deletion request received from the image forming apparatus 1.

Note that, since examples of the mode of transmitting a copied data deletion request are the same as the copied data deletion first process, copied data deletion second process, and copied data deletion third process explained using FIGS. 4, 5 and 6, reference should be made to the explanation of these processes, and explanation is omitted here. Besides, since the image formation process performed using copied data means the situation where abnormality occurs, automatic deletion of copied data may not be performed for security reasons.

When occurrence of abnormality is not detected in step S501 (S501: NO), the copied data image formation process is finished without performing the processes of steps S502 through S507. In the case where abnormality related to an image formation process is detected in this manner, by transmitting the copied data to the image forming apparatus 1 from the recording apparatus 2 and performing an image formation process, it is possible to perform the image formation process even when abnormality occurs, and reliability can be improved.

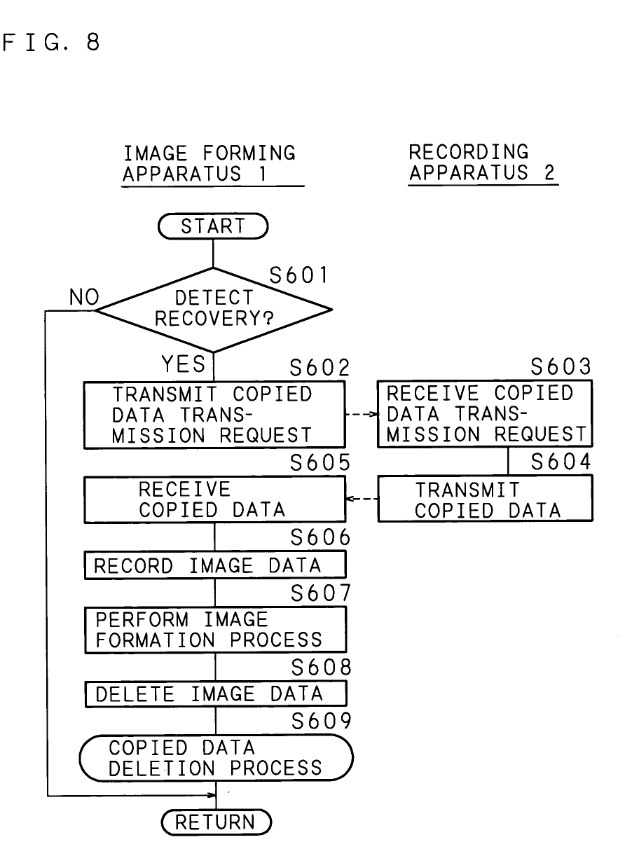

FIG. 8 is a flowchart showing an image data rerecording process of the image forming apparatus 1 and the recording apparatus 2 used in the image forming system of Embodiment 1 of the present invention. The image data rerecording process is a process of recording the image data again in the image recording section 110 and performing an image formation process when, for example, the broken image recording section 110 has recovered.

Under the control of the controller 101, the image forming apparatus 1 detects whether of not the broken image recording section 110 has recovered (S601), and, when the recovery is detected (S601: YES), it transmits, from the internal communication section 106 to the recording apparatus 2, a copied data transmission request for transmission of the copied data based on the content recorded in the job management section 109 (S602). In step S601, instead of automatically detecting the recovery of the image recording section 110 by the image forming apparatus 1, it may be possible to receive an operation of an operator who confirmed the recovery, and regard this as the detection of recovery. Besides, copied data requested to be transmitted does not include copied data corresponding image data for which the image formation process has been completed correctly.

In the recording apparatus 2, under the control of the controller 201, the copied data transmission request is received by the internal communication section 204 (S603), and the copied data recorded in the recording section 202 is transmitted from the internal communication section 204 to the image forming apparatus 1 in response to the received copied data transmission request (S604).

In the image forming apparatus 1, under the control of the controller 101, the copied data is received by the internal communication section 106 (S605), the received copied data is recorded as image data in the image recording section 110 (S606), an image formation process of forming an image to be printed and printing the image is performed by the processing of the printing section 108 based on the recorded image data, after the completion of recording of the copied data (S607), and the image data recorded in the image recording section 110 is deleted after the image formation process is finished (S608). Then, in the image forming apparatus 1, under the control of the controller 101, a copied data deletion process of transmitting, from the internal communication section 106 to the recording apparatus 2, a copied data deletion request for deletion of copied data based on the settings recorded in the setting recording section 111 is performed (S609).

In the recording apparatus 2, the copied data recorded in the recording section 202 is deleted based on the copied data deletion request received from the image forming apparatus 1.

Note that, since examples of the mode of transmitting the copied data deletion request are the same as the copied data deletion first process, copied data deletion second process, and copied data deletion third process explained using FIGS. 4, 5 and 6, reference should be made to the explanation of these processes, and explanation is omitted here.

When the recovery of the image recording section 110 is not detected in step S601 (S601: NO), the image data rerecording process is finished without performing the processes of steps S602 through S609.

Next, the following description will explain an image data saving process of the image forming system of Embodiment 1 of the present invention. The image data saving process is a process of saving a part or all of received image data in the recording apparatus 2 when the received image data exceeds the recording capacity of the image recording section 110 of the image forming apparatus 1.

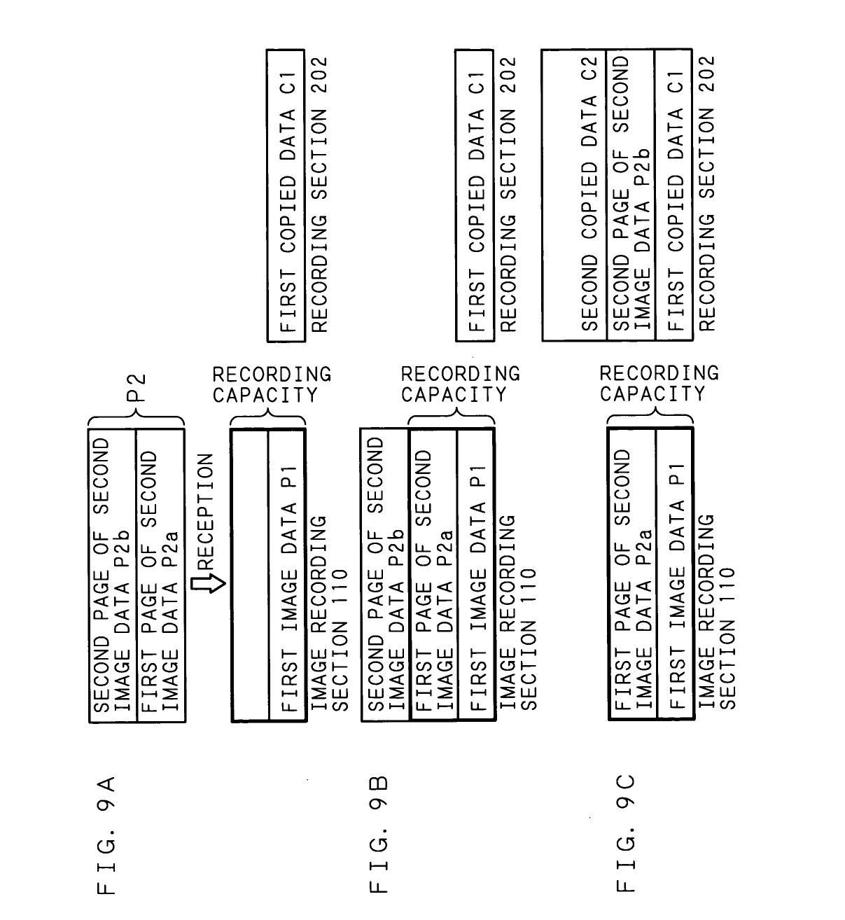

FIGS. 9A through 9C are explanatory views showing the concept of the image data saving process of the image forming system of Embodiment 1 of the present invention. FIG. 9A shows the state in which the image forming apparatus 1 that received first image data P1 receives second image data P2 including the first page of second image data P2a and the second page of second image data P2b at a stage at which the image forming apparatus 1 has recorded the first image data in the image recording section 110 and recorded copied data C1 of the first image data P1 (hereinafter referred to as the first copied data C1) in the recording section 202 of the recording apparatus 2.

As shown in FIG. 9B, since the recording capacity of the image recording section 110 of the image forming apparatus 1 is smaller than the total value of the size of the first image data P1 and the size of the second image data P2, it is impossible to record the first image data P1 and second image data P2. Therefore, as the image data saving process, as shown in FIG. 9C, the first image data P1 and the first page of second image data P2a are recorded in the image recording section 110 of the image forming apparatus 1, and the first copied data C1 and the second page of second image data P2b and copied data C1 of the second image data P2 (hereinafter referred to as the second copied data C2) are recorded in the recording section 202 of the recording apparatus 2. In short, the process of saving the second page of second image data P2b in the recording section 202 of the recording apparatus 2 is performed. Note that it may also be possible to record all the second image data P2 in the recording section 202 of the recording apparatus 2, or record the first half of the same page in the image recording section 110 of the image forming apparatus 1 and record the second half in the recording section 202 of the recording apparatus 2.

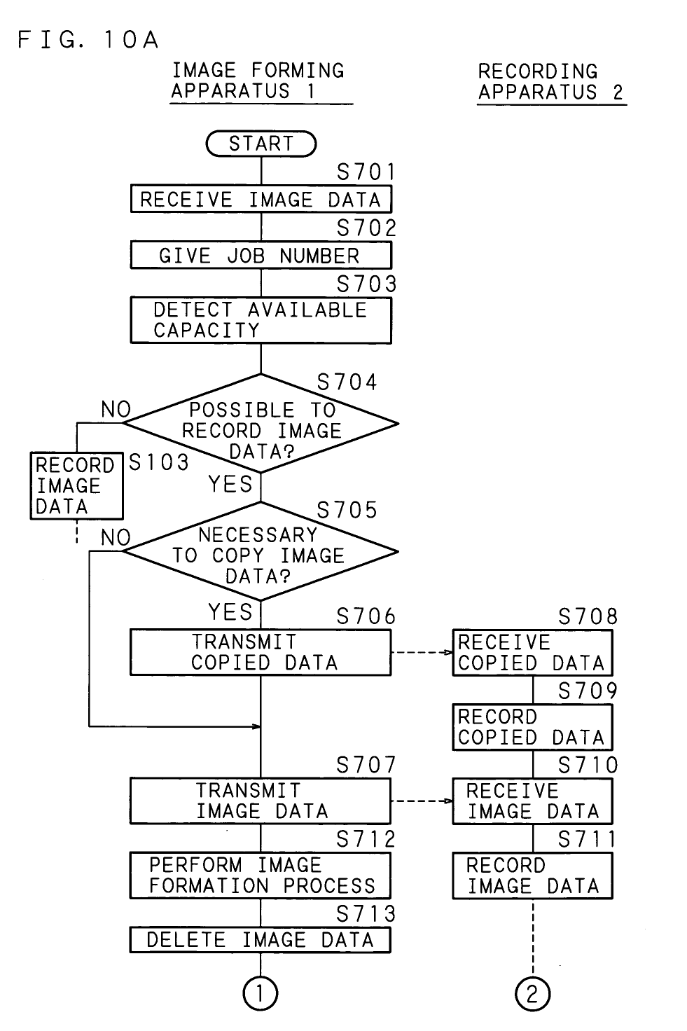

FIGS. 10A and 10B are a flowchart showing the image data saving process of the image forming apparatus 1 and the recording apparatus 2 used in the image forming system of Embodiment 1 of the present invention. Here, as shown in FIGS. 9A through 9C, an explanation will be given of a process corresponding to the situation where the image forming apparatus 1 that received the first image data P1 receives the second image data P2 including the first page of second image data P2a and the second page of second image data P2b at a stage at which the image forming apparatus 1 has recorded the first image data P1 in the image recording section 110 and recorded the first copied data C1 in the recording section 202 of the recording apparatus 2.

In the image forming apparatus, 1, under the control of the controller 101, image data such as facsimile data corresponding to the second image data P2 of FIGS. 9A through 9C which is transmitted through the external communication network NWo is received by the external communication section 105 (S701), a job number for identifying the received image data is given (S702), the available capacity of the image recording section 110 is detected (S703), and a judgment is made as to whether or not it is possible to record the image data in the image recording section 110, based on the detected available capacity (S704). The judgment as to whether or not it is possible to record the image data of step S704 is made by comparing the available capacity of the image recording section 110 with a predetermined value and/or comparing the available capacity of the image recording section 110 with the size of the received image data.

In step S704, if recording of the image data in the image recording section 110 is judged impossible (S704: NO), in the image forming apparatus 1, under the control of the controller 101, a judgment is made as to whether or not it is necessary to copy the received image data, based on the settings recorded in the setting recording section 111 (S705), and, if copying of the image data is judged necessary (S705: YES), copied data obtained by copying the received image data is transmitted to the recording apparatus 2 from the internal communication section 106 through the internal communication network NWi (S706). Besides, after transmitting the copied data for recording in the recording apparatus 2, the recorded conditions and recorded location of the copied data are recorded in the job management section 109.

In step S705, if copying of the image data is judged unnecessary (S705: NO), the transmission process of copied data shown in step S706 is not performed. Moreover, in the image forming apparatus 1, under the control of the controller 101, a part or all of the received image data is transmitted to the recording apparatus 2 from the internal communication section 106 through the internal communication network NWi (S707). In the case where the image data transmitted in step S707 is a part of the received image data, a portion of the image data which was not transmitted is recorded in the image recording section 110. For example, the image data corresponding to the first page is recorded in the image recording section 110, and the image data corresponding to the second page is transmitted to the recording apparatus 2.

In the above-mentioned embodiment, the transmission process of copied data shown in step S706 and the transmission process of image data shown in step S707 are actually performed concurrently, and, since the received image data is consecutively recorded in the receiving buffer and the image data corresponding to a part which was completely transmitted to the recording apparatus 2 is consecutively deleted from the receiving buffer, it is possible to efficiently use the recording capacity of the receiving buffer. Note that it may also be possible to transmit only the image data to the recording apparatus 2 and arrange the recording apparatus 2 which received the image data to record the received image data, obtain copied data by copying the image data, and record the copied data.

In the recording apparatus 2, under the control of the controller 201, the copied data is received by the internal communication section 204 (S708), the received copied data is recorded in the recording section 202 (S709), further image data is received (S710), and the received image data is recorded in the recording section 202 (S711).

In the image forming apparatus 1, under the control of the controller 101, after completion of transmission of the copied data and image data, an image formation process of forming an image to be printed and printing the image is performed by the processing of the printing section 108 based on the image data corresponding to the first image data P1 of FIGS. 9A through 9C recorded in the image recording section 110 (S712), the image data recorded in the image recording section 110 is deleted after the image formation process is finished (S713), and an image data transmission request for transmission of image data corresponding to the second image data P2 of FIGS. 9A through 9C is transmitted to the recording apparatus 2 from the internal communication section 106 through the internal communication network NWi (S714).

In the recording apparatus 2, under the control of the controller 201, the image data transmission request is received by the internal communication section 204 (S715), and the image data recorded in the recording section 202 is transmitted from the internal communication section 204 to the image forming apparatus 1 in response to the received image data transmission request (S716).

In the image forming apparatus 1, under the control of the controller 101, the image data is received by the internal communication section 106 (S717), the received image data is recorded in the image recording section 110 after completion of receiving of the image data (S718), an image formation process of forming an image to be printed and printing the image is performed by the processing of the printing section 108 based on the recorded image data (S719), the image data recorded in the image recording section 110 is deleted after the image formation process is finished (S720), and further an image data deletion request for deletion of the image data is transmitted to the recording apparatus 2 from the internal communication section 106 through the internal communication network NWi (S721). Note that although the copied data and image data are both recorded in the recording apparatus 2, the copied data will not be transmitted to the image forming apparatus 1 from the recording apparatus 2 and an image formation process based on the copied data will not be performed in the image forming apparatus 1 by managing the data by the job number.

In the recording apparatus 2, under the control of the controller 201, the image data deletion request is received by the internal communication section 204 (S722), and the image data specified by the image data deletion request is deleted from the recording section 202 based on the received image data deletion request (S723). Moreover, in the image forming apparatus 1, under the control of the controller 101, a copied data deletion process of transmitting, from the internal communication section 106 to the recording apparatus 2, a copied data deletion request for deletion of copied data based on the settings recorded in the setting recording section 111 is performed (S724). In the recording apparatus 2, the copied data recorded in the recorded section 202 is deleted based on the copied data deletion request received from the image forming apparatus 1.

In step S704, if recording of the image data in the image recording section 110 is judged possible (S704: YES), the operation moves to step S103 of the image formation process explained using FIG. 2, and the image forming apparatus 1 executes the process of step S103 of recording the image data having the job number as a job in the image recording section 110 and the following processes. With such an image data saving process, it is possible to avoid the situation where receiving of image data is delayed due to insufficient available capacity of the image recording section 100 of the image forming apparatus 1 and a communication line is occupied.

### EMBODIMENT 2

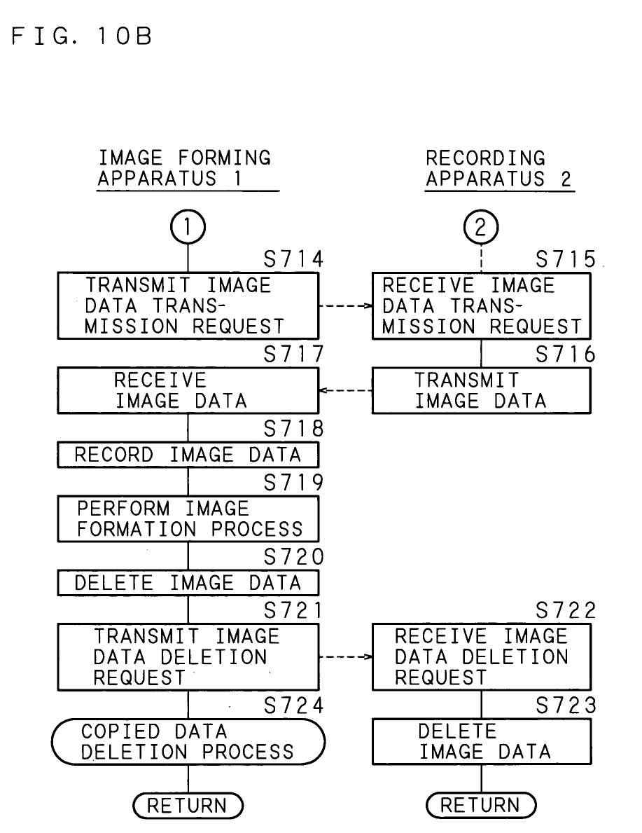

According to Embodiment 2, in Embodiment 1, a plurality of recording apparatuses 2, 2, . . . are connected to the internal communication network NWi. FIG. 11 is a block diagram showing the configuration of an image forming system of Embodiment 2 of the present invention. In Embodiment 2, as shown in FIG. 11, a first recording apparatus 2a and a second recording apparatus 2b are connected to the internal communication network NWi.

The first recording apparatus 2a comprises a controller 201a; a recording section (second recording means) 202a such as a hard disk; a RAM 203a; and an internal communication section 204a. The second recording apparatus 2b comprises a controller 201b; a recording section (second recording means) 202b such as a hard disk; a RAM 203b; and an internal communication section 204b. Since other structures are the same as those of Embodiment 1, the same reference codes as in Embodiment 1 are given, and the explanation of these structures is omitted.

Next, the following description will explain the processes performed by various apparatuses used in the image forming system of Embodiment 2 of the present invention. In Embodiment 2, since a plurality of recording apparatuses are used, it is possible to select a recording apparatus in which copied data is to be recorded, based on a preset priority order and the available capacity of the plurality of recording apparatuses.

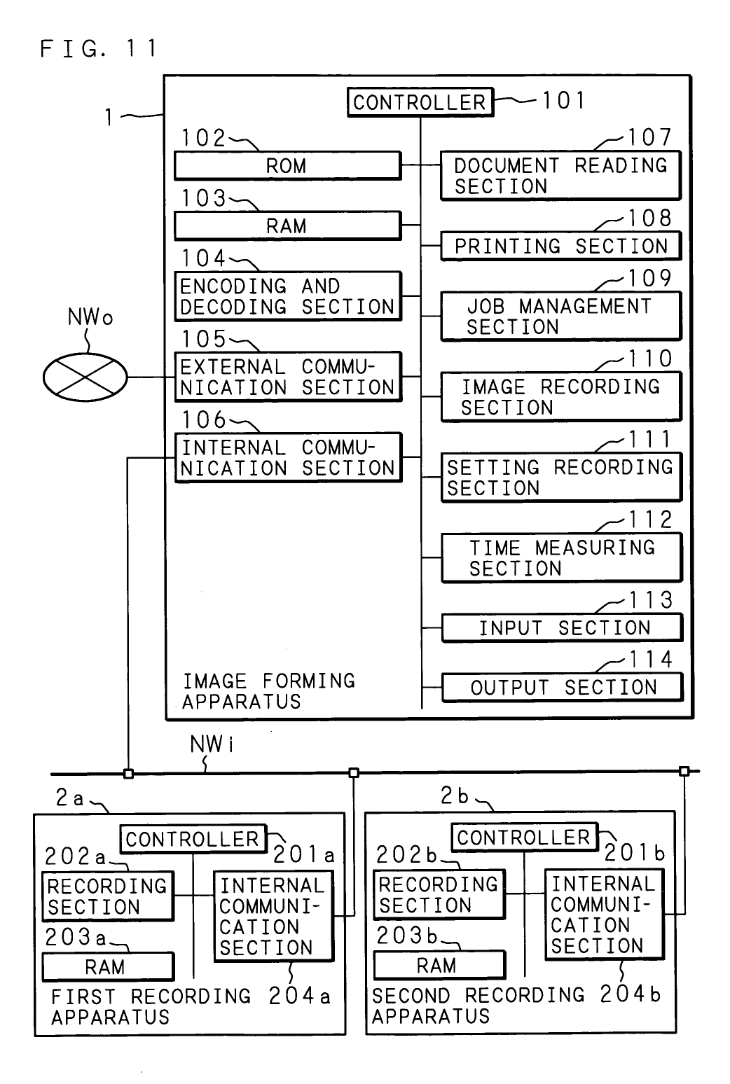

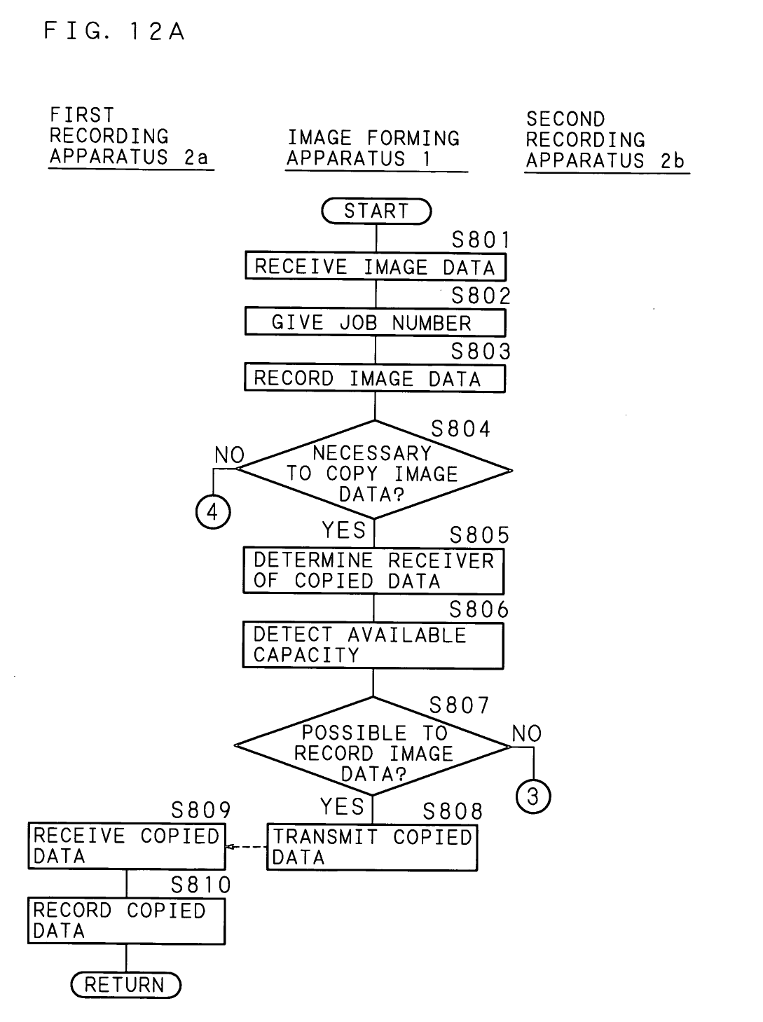

FIGS. 12A and 12B are a flowchart showing an image formation process of the image forming apparatus 1, the first recording apparatus 2a and the second recording apparatus 2b used in the image forming system of Embodiment 2 of the present invention. In the image forming apparatus 1, under the control of the controller 101, image data such as facsimile data transmitted through the external communication network NWo is received by the external communication section 105 (S801), a job number for identifying the received image data is given (S802), and the image data having the job number is recorded as a job in the image recording section 110 (S803). In addition, a job number list indicating the index of the image data recorded in the image recording section 110 is recorded in the job management section 109.

Then, in the image forming apparatus 1, under the control of the controller 101, after completion of receiving and recording of the image data, a judgment is made as to whether or not it is necessary to copy the image data recorded based on the settings recorded in the setting recording section 111 (S804), and, if copying of the image data is judged necessary (S804: YES), a receiver of the copied data is determined from the first recording apparatus 2a and the second recording apparatus 2b based on the settings recorded in the setting recording section 111 (S805). Here, a higher priority order is given to the first recording apparatus 2a, and thus the following processes are explained on the assumption that the first recording apparatus 2a is determined to be the receiver.

In the image forming apparatus 1, under the control of the controller 101, the available capacity of the recording section 202a of the first recording apparatus 2a determined to be a receiver of copied data is detected (S806), and a judgment is made as to whether or not it is possible to record the copied data in the first recording apparatus 2a, based on the detected available capacity and the size of the copied data to be transmitted (S807). In step S807, if recording of the copied data in the first recording apparatus 2a is judged possible (S807: YES), the copied data obtained by copying the image data recorded in the image recording section 110 is transmitted to the first recording apparatus 2a from the internal communication section 106 through the internal communication network NWi (S808).

In the first recording apparatus 2a, under the control of the controller 201a, the copied data is received by the internal communication section 204a (S809), and the received copied data is recorded in the recording section 202a (S810). In step S807, if recording of the copied data in the first recording apparatus 2a is judged impossible (S807: NO), in the image forming apparatus 1, under the control of the controller 101, the second recording apparatus 2b to which the second highest priority order is given next to the first recording apparatus 2a is determined to be a receiver of the copied data (S811), and the copied data obtained by copying the image data recorded in the image recording section 110 is transmitted to the second recording apparatus 2b from the internal communication section 106 through the internal communication network NWi (S812). Note that, when recording of the copied data is judged impossible based on the available capacity of the recording section 202b of the second recording apparatus 2b, a further process, such as transmission of the copied data to other recording apparatus or cancellation of the transmission of the copied data, is performed.

In the second recording apparatus 2b, under the control of the controller 201b, the copied data is received by the internal communication section 204b (S813), and the received copied data is recorded in the recording section 202b (S814). Note that it may be possible to divide the copied data, transmit the divided pieces of the copied data to the first recording apparatus 2a and the second recording apparatus 2b, respectively, and record the copied data in the respective recording apparatuses. Alternatively, it may be possible to transmit the copied data to the first recording apparatus 2a without performing the detection of the available capacity by the image forming apparatus 1, and, if the received copied data cannot be recorded in the first recording apparatus 2a, transmit a part or all of the copied data which cannot be recorded in the first recording apparatus 2a to the second recording apparatus 2b from the first recording apparatus 2a and record the copied data in the second recording apparatus 2b.

In step S804, if copying of the image data is judged unnecessary (S804: NO), the processes of determining a receiver of the copied data and transmitting the copied data shown in steps S805 through S812 are not performed. In the image forming apparatus 1, under the control of the controller 101, after completion of the transmission of the coped data, an image formation process of forming an image to be printed and printing the image is performed by the processing of the printing section 108 based on the image data recorded in the image recording section 110 (S815), and the image data recorded in the image recording section 110 is deleted after the image formation process is finished (S816).

Then, in the image forming apparatus 1, under the control of the controller 101, a copied data deletion process of transmitting, from the internal communication section 106 to the recording apparatus 2, a copied data deletion request for deletion of copied data based on the settings recorded in the setting recording section 111 is performed (S817). The first recording apparatus 2a or second recording apparatus 2b which received the copied data deletion request deletes copied data based on the copied data deletion request received from the image forming apparatus 1. Note that, when abnormality related to the image formation process is detected, similarly to Embodiment 1, the image formation process is performed based on the copied data recorded in the first recording apparatus 2a or the second recording apparatus 2b. Moreover, various kinds of processes, such as various types of copied data deletion processes, copied data image formation process and image data rerecording process shown in Embodiment 1, can also be applied to Embodiment 2.

Next, the following description will explain an image data saving process of the image forming system of Embodiment 2 of the present invention. The image data saving process in Embodiment 2 is the process corresponding to the image data saving process of Embodiment 1 explained using FIGS. 9A through 9C and FIGS. 10A and 10B, and enables a recording location of image data and copied data to be selected from the first recording apparatus 2a and the second recording apparatus 2b.

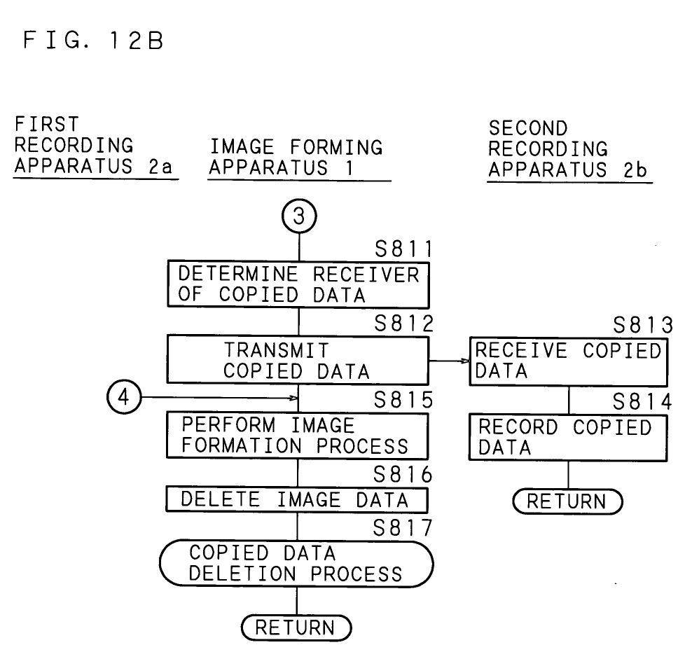

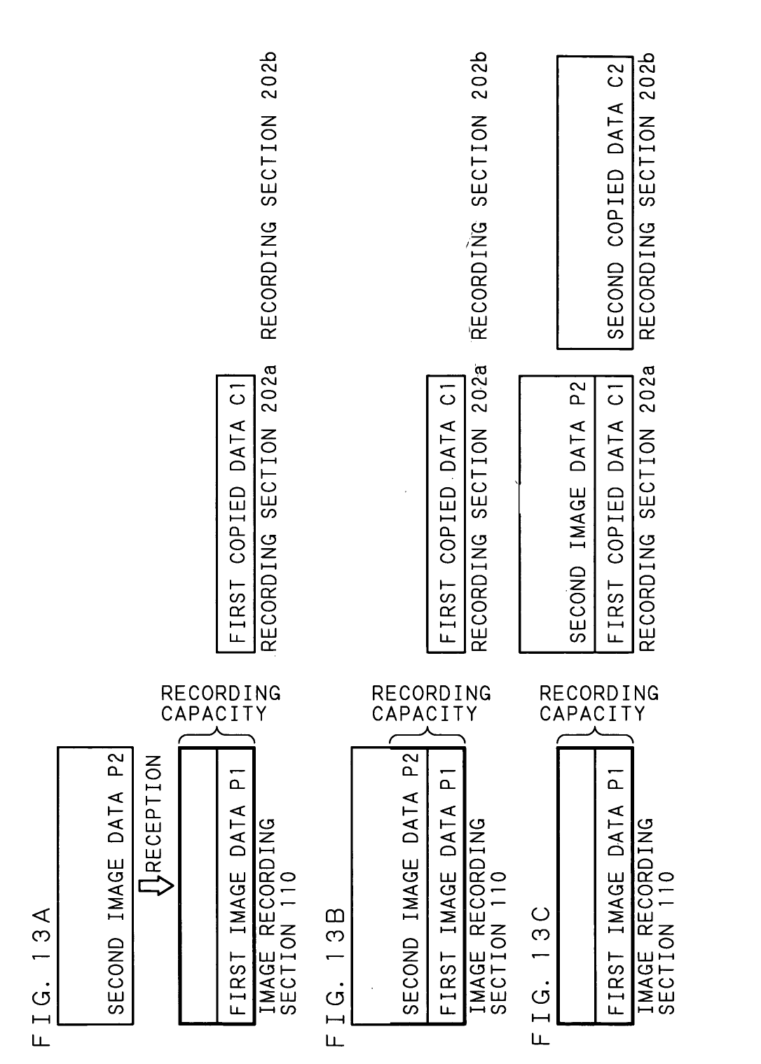

FIGS. 13A through 13C are explanatory views showing the concept of an image data saving process of the image forming system of Embodiment 2 of the present invention. FIG. 13A shows the state in which the image forming apparatus 1 that received the first image data P1 receives the second image data P2 at a stage at which the image forming apparatus 1 has recorded the first image data P1 in the image recording section 110 and recorded the first copied data C1 in the recording section 202a of the first recording apparatus 2a, but data concerning the corresponding process has not been recorded in the recording section 202b of the second recording apparatus 2b.

As shown in FIG. 13B, since the recording capacity of the image recording section 110 of the image forming apparatus 1 is smaller than the total value of the size of the first image data P1 and the size of the second image data P2, it is impossible to record the first image data P1 and second image data P2. Therefore, as the image data saving process, as shown in FIG. 13C, the first image data P1 is recorded in the image recording section 110 of the image forming apparatus 1, the first copied data C1 and the second image data P2 are recorded in the recording section 202a of the first recording apparatus 2a, and the second copied data C2 is recorded in the recording section 202b of the second recording apparatus 2b. In short, the process of saving the second image data P2 in the recording section 202a of the first recording apparatus 2a and recording the second copied data in the recording section 202b of the second recording apparatus 2b is performed.

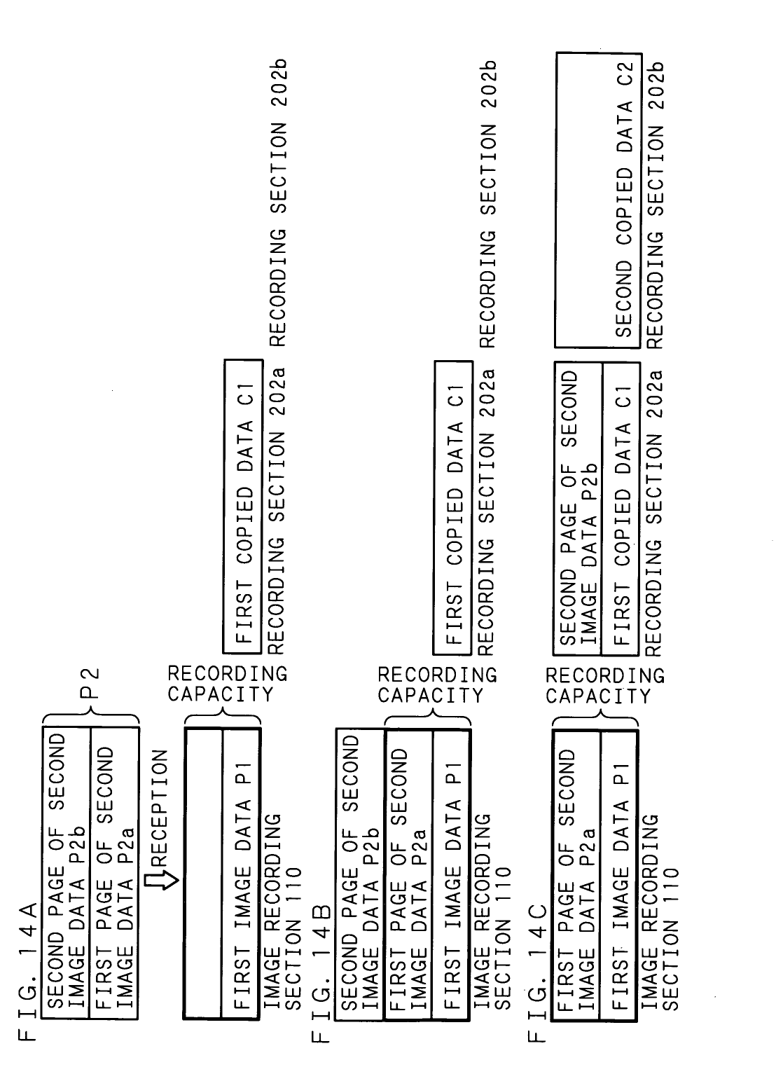

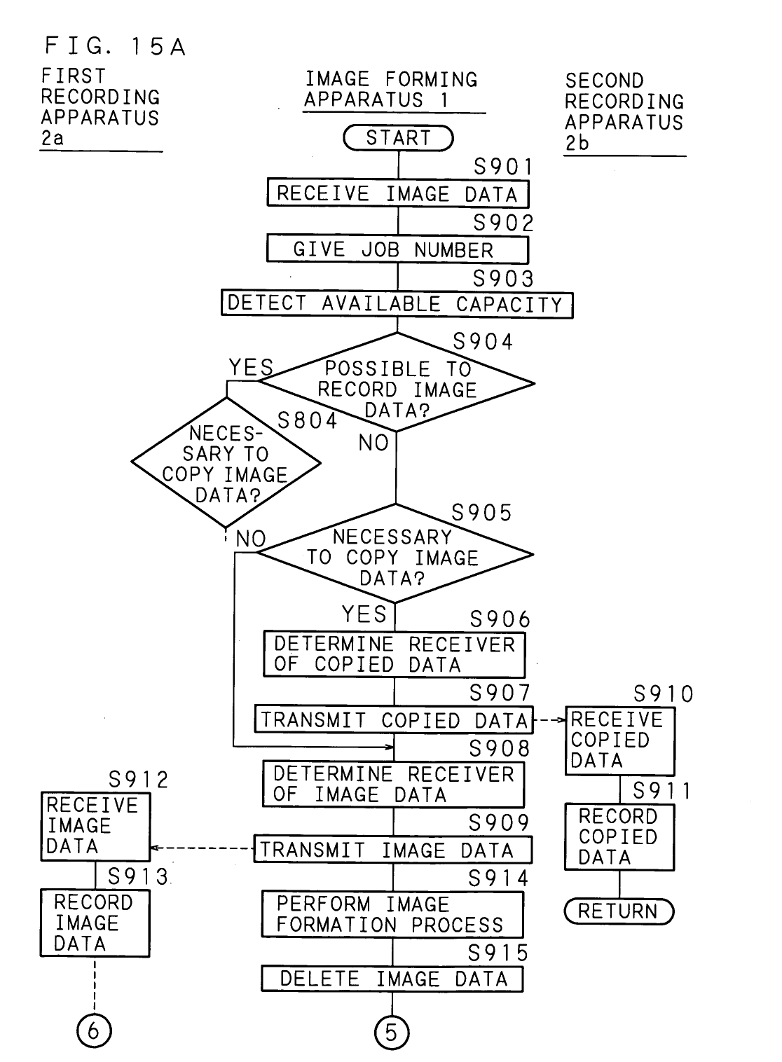

FIGS. 14A through 14C are explanatory views showing the concept of an image data saving process of the image forming system of Embodiment 2 of the present invention. FIG. 14A shows the state in which the image forming apparatus 1 that received the first image data P1 receives the second image data P2 including the first page of second image data P2a and the second page of second image data P2b at a stage at which the image forming apparatus 1 has recorded the first image data P1 in the image recording section 110 and recorded the first copied data C1 in the recording section 202a of the first recording apparatus 2a, but data concerning the corresponding process has not been recorded in the recording section 202b of the second recording apparatus 2b.

As shown in FIG. 14B, since the recording capacity of the image recording section 110 of the image forming apparatus 1 is smaller than the total value of the size of the first image data P1 and the size of the second image data P2, it is impossible to record the first image data P1 and second image data P2. Therefore, as the image data saving process, as shown in FIG. 14C, the first image data P1 and the first page of second image data P2a are recorded in the image recording section 110 of the image forming apparatus 1, the first copied data C1 and the second page of second image data P2b are recorded in the recording section 202a of the first recording apparatus 2a, and the second copied data C2 is recorded in the recording section 202b of the second recording apparatus 2b. In short, the process of saving the second page of second image data P2b in the recording section 202a of the first recording apparatus 2a and recording the second copied data in the recording section 202b of the second recording apparatus 2b is performed.

As shown in FIGS. 13A through 13C and FIGS. 14A through 14C, when image data exceeding the recording capacity of the image recording section 110 of the image forming apparatus 1 is received, a part or all of the received image data is recorded in the first recording apparatus 2a as the image data saving process. Note that it may be possible to use the second recording apparatus 2b as the location in which the image data is to be saved, or it may be possible to select an optimum saving method according to a situation, for example, saving the first page in the first recording apparatus 2a and saving the second page in the second recording apparatus 2b.

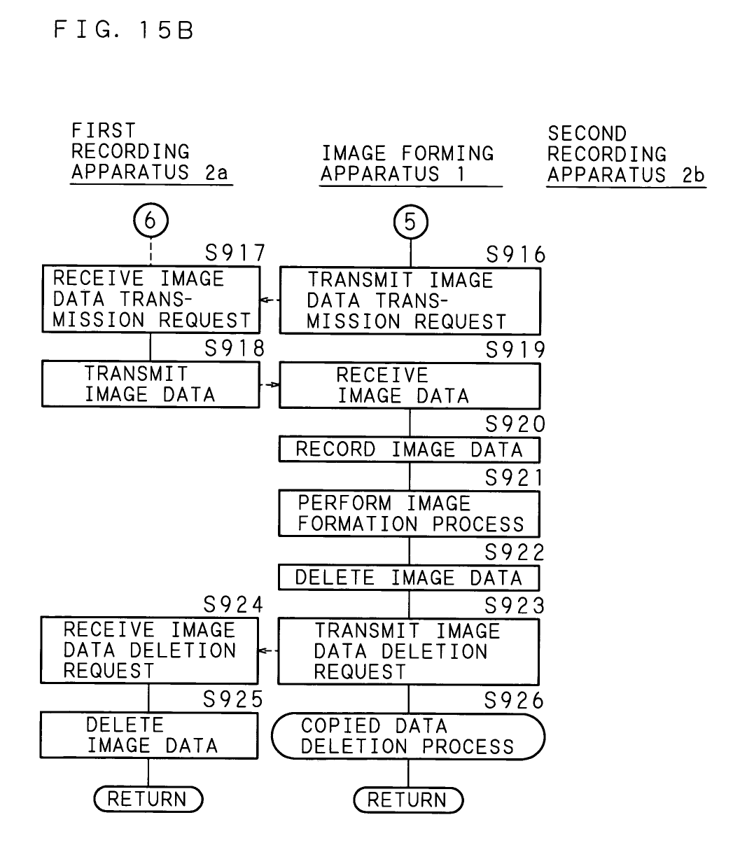

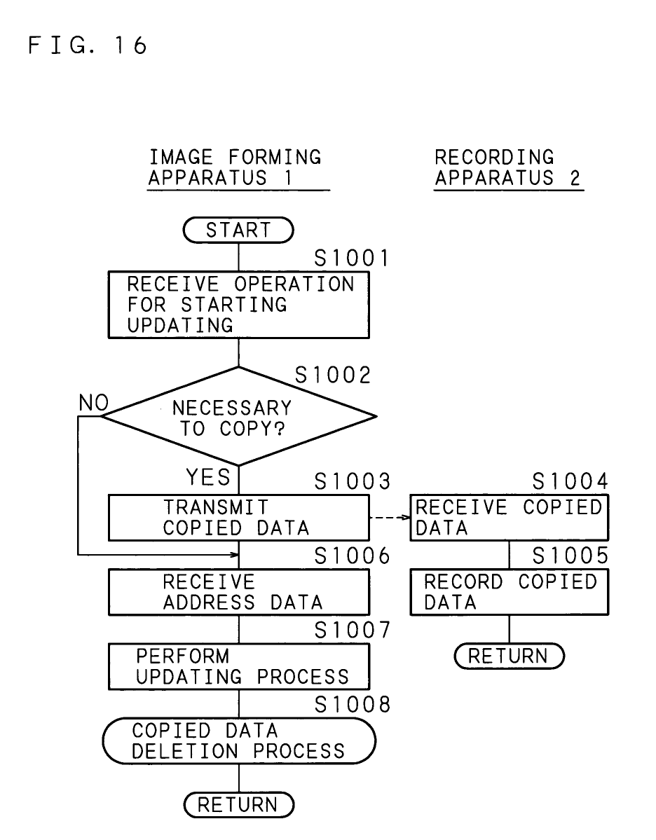

FIGS. 15A and 15B are a flowchart showing the image data saving process of the image forming apparatus 1, the first recording apparatus 2a and the second image forming apparatus 2b used in the image forming system of Embodiment 2 of the present invention. Here, as shown in FIGS. 13A through 13C and FIGS. 14A through 14C, an explanation will be given of a process corresponding to the situation where the image forming apparatus 1 that received the first image data P1 receives the second image data P2 at a stage at which the image forming apparatus 1 has recorded the first image data P1 in the image recording section 110 and recorded the first copied data C1 in the recording section 202a of the first recording apparatus 2a.

In the image forming apparatus 1, under the control of the controller 101, image data such as facsimile data corresponding to the second image data P2 of FIGS. 13A through 13C and FIGS. 14A through 14C which is transmitted through the external communication network NWo is received by the external communication section 105 (S901), a job number for identifying the received image data is given (S902), the available capacity of the image recording section 110 is detected (S903), and a judgment is made as to whether or not it is possible to record the image data in the image recording section 110, based on the detected available capacity (S904). The judgment as to whether or not it is possible to record the image data of step S904 is made by comparing the available capacity of the image recording section 110 with a predetermined value and/or comparing the available capacity of the image recording section 110 with the size of the received image data.

In step S904, if recording of the image data in the image recording section 110 is judged impossible (S904: NO), in the image forming apparatus 1, under the control of the controller 101, a judgment is made as to whether or not it is necessary to copy the received image data based on the settings recorded in the setting recording section 111 (S905), and, if copying of the image data is judged necessary (S905: YES), a receiver of the copied data is determined from the first recording apparatus 2a and the second recording apparatus 2b based on the settings recorded in the setting recording section 111 (S906), and copied data obtained by copying the received image data is transmitted to the recording apparatus, here the second recording apparatus 2b, from the internal communication section 106 through the internal communication network NWi (S907). In the receiver determining process of step S906, the available capacity of the recording section 202a of the first recording apparatus 2a and the recording section 202b of the second recording apparatus 2b is detected according to a need, and a receiver is determined based on the detected available capacity. Besides, after transmitting the copied data for recording in the second recording apparatus 2b, the recorded conditions and recorded location of the copied data are recorded in the job management section 109. In step S905, if copying of the image data is judged unnecessary (S905: NO), the processes of determining a receiver of the copied data and transmitting the copied data shown in steps S906 and S907 are not performed.

Further, in the image formatting apparatus 1, under the control of the controller 101, a receiver of received image data is determined from the first recording apparatus 2a and the second recording apparatus 2b based on the settings recorded in the setting recording section 111 (S908), and the received image data is transmitted from the internal communication section 106 through the internal communication network NWi to the recording apparatus determined in step S908, here the first recording apparatus 2a (S909). In the case where the image data transmitted in step S909 is a part of the received image data, a portion of the image data which was not transmitted is recorded in the image recording section 110. In the above-mentioned embodiment, the transmission process of copied data shown in step S907 and the transmission process of image data shown in step S909 are actually performed concurrently, and the received image data is consecutively recorded in the receiving buffer, and the image data corresponding to a part which was completely transmitted to the first recording apparatus 2a is consecutively deleted from the receiving buffer.

In the second recording apparatus 2b, under the control of the controller 201b, the copied data is received by the internal communication section 204b (S910), and the received copied data is recorded in the recording section 202b (S911). In the first recording apparatus 2a, under the control of the controller 201a, the image data is received by the internal communication section 204a (S912), and the received image data is recorded in the recording section 202a (S913).

In the image forming apparatus 1, under the control of the controller 101, after completion of transmission of the copied data and image data, an image formation process of forming an image to be printed and printing the image is performed by the processing of the printing section 108 based on the image data corresponding to the first image data P1 of FIGS. 13A through 13C or FIGS. 14A through 14C (S914), the image data recorded in the image recording section 110 is deleted after the image formation process is finished (S915), and an image data transmission request for transmission of image data corresponding to the second image data P2 of FIGS. 13A through 13C or FIGS. 14A through 14C is transmitted to the first recording apparatus 2a from the internal communication section 106 through the internal communication network NWi (S916). In the first recording apparatus 2a, under the control of the controller 201a, the image data transmission request is received by the internal communication section 204a (S917), and the image data recorded in the recording section 202a is transmitted to the image forming apparatus 1 from the internal communication section 204a in response to the received image data transmission request (S918).

In the image forming apparatus 1, under the control of the controller 101, the image data is received by the internal communication section 106 (S919), the received image data is recorded in the image recording section 110 after completion of receiving of the image data (S920), an image formation process of forming an image to be printed and printing the image is performed by the processing of the printing section 108 based on the recorded image data (S921), the image data recorded in the image recording section 110 is deleted after the image formation process is finished (S922), and further an image data deletion request for deletion of the image data is transmitted to the first recording apparatus 2a from the internal communication section 106 through the internal communication network NWi (S923). In the first recording apparatus 2a, under the control of the controller 201a, the image data deletion request is received by the internal communication section 204a (S924), and the image data specified by the image data deletion request is deleted from the recording section 202a based on the received image data deletion request (S925).

Moreover, in the image forming apparatus 1, under the control of the controller 101, a copied data deletion process of transmitting a copied data deletion request for deletion of copied data to the first recording apparatus 2a and second recording apparatus 2b from the internal communication section 106 is performed based on the settings recorded in the setting recording section 111 (S926). In the first recording apparatus 2a, the copied data recorded in the recorded section 202a is deleted based on the copied data deletion request received from the image forming apparatus 1, and, in the second recording apparatus 2b, the copied data recorded in the recorded section 202b is deleted based on the copied data deletion request received from the image forming apparatus 1. In step S904, if recording of the image data in the image recording section 110 is judged possible (S904: YES), the operation moves to step S804 of the image formation process explained using FIG. 12A, and the image forming apparatus 1 executes the process of step S804 of judging whether or not it is necessary to copy the image data and the following processes.

### EMBODIMENT 3

Embodiments 1 and 2 illustrate an embodiment in which image data and/or copied data are transmitted to the recording apparatus 2 from the image forming apparatus 1 and recorded in the recording apparatus 2, but it may be possible to record data other than image data and copied data in the recording apparatus 2. Embodiment 3 explains an embodiment in which, as the data other than image data and copied data, copied data of address data representing an address book recording the name and facsimile number of a receiver of facsimile data in association with each other is recorded in the recording apparatus 2. Note that, since the configuration of an image forming system of Embodiment 3 is the same as that of Embodiment 1, reference should be made to Embodiment 1, and explanation of the configuration is omitted here.

Next, the following description will explain the processes performed by various apparatuses used in the image forming system of Embodiment 3 of the present invention. FIG. 16 is a flowchart showing an address book updating process of the image forming apparatus 1 and the recording apparatus 2 used in the image forming system of Embodiment 3 of the present invention. When there is a need to update the address book, such as for change of a facsimile number recorded in the address book and addition of a facsimile number, the operator operates the image forming apparatus 1 and operates the input section 13 to update the address book.

In the image forming apparatus 1, under the control of the controller 101, the operation for starting updating of the address book is received from the input section 113 (S1001), a judgment is made as to whether or not it is necessary to copy address data based on the settings recorded in the setting recording section 111 (S1002), and, if copying of the address data is judged necessary (S1002: YES), copied data obtained by copying the recorded address data before updated is transmitted to the recording apparatus 2 from the internal connection section 106 through the internal communication network NWi (S1003). In step S1002, if copying of the address data is judged unnecessary (S1002: NO), the transmission process of copied data shown in step S1003 is not performed. In the recording apparatus 2, under the control of the controller 201, the copied data is received by the internal communication section 204 (S1004), and the received copied data is recorded in the recording section 202 (S1005).

In the image forming apparatus 1, under the control of the controller 101, new address data is received from the input section 113 after completion of the transmission of the copied data (S1006), an updating process of the address data based on the received address data is performed (S1007), and a copied data deletion process of transmitting, from the internal communication section 106 to the recording apparatus 2, a copied data deletion request for deletion of the copied data based on the settings recorded in the setting recording section 111 is performed (S1008). In the recording apparatus 2, the copied data recorded in the recording section 202 is deleted based on the copied data deletion request received from the image forming apparatus 1. Note that, when abnormality related to the updating process of address data is detected, similarly to Embodiment 1, a process based on the copied data recorded in the recording apparatus 2, here a restoration process of address data, is performed.

If the image forming apparatus 1 of the present invention that performs an image formation process based on image data as illustrated in the above-described Embodiments 1, 2 and 3 is a data processor for performing data processing based on object data to be processed, then it is possible to say that the data processor of the present invention is an apparatus which receives object data to be processed such as image data and address data, records copied data obtained by copying the received object data which is image data or copying relevant data which is the address data before updated related to the object data which is address data, in the recording apparatus 2, performs data processing, such as an image formation process and an address data updating process, based on the object data, and performs a process, such as an image formation process based on the copied data recorded in the recording apparatus 2 and an address data restoration process, when abnormality is detected in the data processing.

Although the above described embodiments explain an embodiment in which a facsimile machine or a digital multi-function machine is used as the image forming apparatus 1 and image data is received as facsimile data, the present invention is not limited to this, and may use an internet facsimile and a digital multi-function machine connectable to the Internet as the image forming apparatus 1, and receive digital image data in the form of BMP, JPEG or the like transmitted from an external apparatus such as a personal computer. Moreover, in the above-described embodiments, an embodiment using a FTP server computer as the recording apparatus 2 is illustrated, but the present invention is not limited to this, and the recording apparatus 2 may be an apparatus capable of communicating with the image forming apparatus 1, such as for example, a HTTP sever computer, a NFS server computer, and a network file server computer belonging to the OS.

As described in detail above, in the image formation method, data processing method, image forming system and image forming apparatus according to the present invention, an image forming apparatus, such as a facsimile machine, and a recording apparatus, such as a FTP server computer, are connected through a communication network such as a LAN, and, in the image forming apparatus, by recording copied data obtained by copying received image data such as facsimile data in the recording apparatus, it is possible to take an appropriate measure when abnormality occurs, such as recovery of image data against the abnormality in an image formation process, without increasing the recording capacity of the recording means of the image forming apparatus.

Additionally, in the present invention, by recording a part or all of image data in the recording apparatus when the available capacity of the recording means of the image forming apparatus is insufficient, it is possible to avoid the situation where receiving of the image data is delayed due to insufficient available capacity of the recording means and a communication line is occupied.

Further, in the present invention, by determining a recording location of the image data from a plurality of recording apparatuses in the case where the available capacity of the recording means of the image forming apparatus is insufficient, it is possible to select a recording apparatus with superior basic performance such as recording capacity, and select an appropriate recording method according to processing conditions, such as recording the data in a plurality of recording apparatuses in a divided manner.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An image formation method using an image forming apparatus, the image forming apparatus including recording means for recording image data and deleting image data recorded in the recording means after an image formation process based on the image data, and a recording apparatus communicating with the image forming apparatus, wherein
the image formation method comprises the steps of:
receiving image data;
recording the received image data in the recording means;
transmitting copied data obtained by copying the image data to the recording apparatus,
recording the received copied data in the recording apparatus, and
performing an image formation process based on the image data recorded in the recording means.

2. A data processing method using a data processor for performing data processing based on object data to be processed, and a recording apparatus communicating with the data processor, wherein
the data processing method comprises the steps of:
receiving object data to be processed;
transmitting copied data obtained by copying the received object data or copying relevant data related to the object data, to the recording apparatus,
recording the copied data received from the data processor in the recording apparatus,
performing data processing based on the object data; and
transmitting to the recording apparatus a copied data transmission request for transmission of the copied data when abnormality is detected in the data processing.

3. An image forming system comprising an image forming apparatus, which has first recording means for recording image data and deletes image data recorded in the first recording means after an image formation process based on the image data, and a recording apparatus having second recording means and communicating with the image forming apparatus, wherein
the image forming apparatus comprises:
means for receiving image data;
means for recording the image data in the first recording means;
means for transmitting copied data obtained by copying the image data to the recording apparatus; and
means for performing an image formation process based on the image data, and
the recording apparatus comprises means for recording the received copied data in the second recording means.

4. The image forming system of claim 3, wherein
the image forming apparatus further comprises:
means for transmitting to the recording apparatus a copied data transmission request for transmission of the copied data when abnormality is detected in the image formation process;
means for receiving the copied data transmitted in response to the copied data transmission request; and
means for performing an image formation process based on the received copied data.

5. The image forming system of claim 3, wherein
the image forming apparatus further comprises deletion request transmitting means for transmitting a copied data deletion request for deletion of copied data to the recording apparatus after the image formation process, and
the recording apparatus further comprises means for deleting the copied data recorded in the second recording means, based on the received copied data deletion request.

6. The image forming system of claim 4, wherein
the image forming apparatus further comprises deletion request transmitting means for transmitting a copied data deletion request for deletion of copied data to the recording apparatus after the image formation process, and
the recording apparatus further comprises means for deleting the copied data recorded in the second recording means, based on the received copied data deletion request.

7. The image forming system of claim 5, wherein
the image forming apparatus further comprises means for measuring time elapsed since an image formation process, and
the deletion request transmitting means transmits a copied data deletion request after a predetermined time has elapsed since the image formation process.

8. The image forming system of claim 6, wherein
the image forming apparatus further comprises means for measuring time elapsed since an image formation process, and
the deletion request transmitting means transmits a copied data deletion request after a predetermined time has elapsed since the image formation process.

9. The image forming system of claim 5, wherein
the image forming apparatus further comprises means for calculating a total value of volume of the copied data recorded in the recording means, and
the deletion request transmitting means transmits a copied data deletion request when the calculated total value exceeds a predetermined value.

10. The image forming system of claim 6, wherein
the image forming apparatus further comprises means for calculating a total value of volume of the copied data recorded in the recording means, and
the deletion request transmitting means transmits a copied data deletion request when the calculated total value exceeds a predetermined value.

11. The image forming system of claim 7, wherein
the image forming apparatus further comprises means for calculating a total value of volume of the copied data recorded in the recording means, and
the deletion request transmitting means transmits a copied data deletion request when the calculated total value exceeds a predetermined value.

12. The image forming system of claim 8, wherein
the image forming apparatus further comprises means for calculating a total value of volume of the copied data recorded in the recording means, and
the deletion request transmitting means transmits a copied data deletion request when the calculated total value exceeds a predetermined value.

13. The image forming system of claim 3, wherein
the image forming apparatus further comprises:
means for judging whether or not it is possible to record the image data in the first recording means, based on an available capacity of the first recording means;
means for transmitting a part or all of image data to the recording apparatus when recording of the image data in the first recording means is judged impossible;
means for transmitting to the recording apparatus an image data transmission request for transmission of the image data;
means for receiving the image data transmitted in response to the image data transmission request; and
means for transmitting an image data deletion request for deletion of the image data to the recording apparatus after the image formation process, and
the recording apparatus further comprises:
means for recording the received image data in the second recording means;
means for transmitting the image data recorded in the second recording means in response to the received image data transmission request; and
means for deleting the image data recorded in the second recording means, based on the received image data deletion request.

14. The image forming system of claim 13, wherein
the image forming apparatus determines a receiver of the image data from a plurality of the recording apparatuses.

15. The image forming system of claim 3, wherein
the image forming apparatus further comprises:
means for detecting an available capacity of the second recording means of a first recording apparatus in a plurality of the recording apparatuses;
means for judging whether or not it is possible to record copied data in the first recording apparatus, based on the detected available capacity and size of copied data to be transmitted; and
means for transmitting a part or all of the copied data to a second recording apparatus different from the first recording apparatus when recording of the copied data in the first recording apparatus is judged impossible.

16. An image forming apparatus having recording means and performing an image formation process based on image data, comprising:
means for receiving image data;
means for recording the image data in the recording means;
means for transmitting copied data obtained by copying the image data to another apparatus; and
means for performing an image formation process based on the image data.

17. An image forming system comprising:
an image forming apparatus for receiving image data comprising a printer for forming an image and having a first memory for storing the image data;
a recording apparatus including a second memory in communication with said printer; and
a controller for sending a copy of said received image data to the recording apparatus, determining whether an image forming process has been completed successfully by said printer and deleting the copy of the received image data in the recording apparatus a given time after the image forming process has been completed successfully by said printer.

18. The image forming apparatus of claim 17 wherein said controller, upon determining that the image forming process has not been completed successfully by said printer, causes an image forming process based on the copy of the received image data to be performed by said printer.

19. A data processing system comprising:
a data processing apparatus for receiving object data to be processed and having a first memory for storing the object data;
a recording apparatus in communication with said data processing apparatus and including a second memory; and
a controller for sending a copy of said received object data to the recording apparatus, determining whether a data processing has been completed successfully by said data processing apparatus and deleting the copy of the received object data in the recording apparatus a given time after the data processing has been completed successfully by said data processing apparatus.

20. The data processing apparatus of claim 19 wherein said controller, upon determining that the data processing has not been completed successfully by said data processing apparatus, causes said data processing apparatus to request a copy of the received object data from the recording apparatus.

21. A method of forming an image comprising the steps of:
providing an image formation apparatus comprising a printer having a first memory;
receiving image data and storing the image data in the first memory;
providing a second memory;
transmitting a copy of the received image data to the second memory;
printing an image from the image data in the first memory;
determining whether the image has printed normally; and
deleting the copy of the received image data if the image has printed normally.

22. The method of claim 21 including the additional step of printing an image from the image data in the second memory if the image has printed abnormally.

23. The method of claim 21 wherein said step of deleting the copy of the received image data if the image has printed normally comprises the step of deleting the copy of the received image data a given time after determining that the image has printed normally.

24. The method of claim 21 wherein said step of deleting the copy of the received image data if the image has printed normally comprises the step of deleting the copy of the received image data a given time after determining that the image has printed normally if an amount of data stored in the second memory exceeds a given value.
